(19) United States
(12) Patent Application Publication
(10) Pub. No.: US 2025/0303332 A1
(43) Pub. Date: Oct. 2, 2025

(54) FILTER STAND

(71) Applicants: Jorge Endara, Valley Village, CA (US); Victor Bayliss, Reseda, CA (US)

(72) Inventors: Jorge Endara, Valley Village, CA (US); Victor Bayliss, Reseda, CA (US)

(21) Appl. No.: 18/624,837

(22) Filed: Apr. 2, 2024

(51) Int. Cl. B01D 46/00; B01D 35/30; B01D 46/24

(52) U.S. Cl. CPC B01D 46/0005; B01D 35/306; B01D 46/2411

(57) ABSTRACT

A filter stand that is capable of receiving and utilizing different types of filters, such as cartridge filters and Diatomaceous Earth (DE) Filters, is provided. The filter stand comprises first and second base members and a filter detachably connected therebetween. Each of the base members includes a top surface and an opposing bottom surface, an outer side wall integrally connected to and extending between the top and bottom surfaces; an opening extending between the top surface and the bottom surface, where an inner side wall extending between the top surface and the bottom surface defines the opening; first and second protrusions extending outward from the side wall into the opening, the first protrusion opposite the second protrusion; and first and second wall members extending perpendicularly upward from the top surface, the first wall member opposite the second wall member and separated by the opening.

### FIELD

Various features relate to devices for securing pool or spa filters above ground.

### BACKGROUND

Swimming pools use filtration systems to ensure clean, clear, and safe swimming water while also prolonging the life of pool equipment and reducing maintenance costs. Pool filtration systems utilize a pump that pulls water to a filter, such as a cartridge filter or a Diatomaceous Earth (DE) filter, which removes dirt and debris from the water and then returns clean water to the pool. The filters can quickly become clogged or occluded by the debris and particulate that they are utilized to contain. As the filter elements become clogged the cleaner can start to operate improperly, for example, the cleaner may lose suction performance. Once the filter elements have become sufficiently clogged or have been occluded to a point that cleaner performance has been reduced below a desired level, the filter elements have to be cleaned or replaced.

Currently, the procedure for cleaning pool filters entails taking the filters out of the filtration system and hosing them off. To hose a filter off, a user holds a single filter with one hand while the other hand is used to hose down the filter. This procedure is both tedious and labor-intensive.

In view of the above, what is needed is a filter stand that can hold multiple filters that will relieve this strain and make cleaning pool filters efficient by cleaning multiple filters at one time. Additionally, a filter stand that is capable of receiving and utilizing different types of filters, such as cartridge filters and Diatomaceous Earth (DE) filters, is needed.

### SUMMARY

The following presents a simplified summary of one or more implementations in order to provide a basic understanding of some implementations. This summary is not an extensive overview of all contemplated implementations and is intended to neither identify key or critical elements of all implementations nor delineate the scope of any or all implementations. Its sole purpose is to present some concepts of one or more implementations in a simplified form as a prelude to the more detailed description that is presented later.

According to one example, a filter assembly is provided. Two or more filter assemblies can be connected together to form a filter stand. The filter assembly comprises a first base member, a second base member, and a filter detachably connected between the first base member and the second base member. The first and second base members are identical and each of the first and second base members comprises a top surface and an opposing bottom surface, an outer side wall integrally connected to and extending between the top and bottom surfaces; an opening extending between the top surface and the bottom surface, where an inner side wall extending between the top surface and the bottom surface defines the opening; first and second protrusions extending outward from the inner side wall into the opening, the first protrusion opposite the second protrusion; and first and second wall members extending perpendicularly upward from the top surface, the first wall member opposite the second wall member and separated by the opening.

According to one aspect, the first and second wall members are integrally connected to the top surface.

According to another aspect, the first and second protrusions are configured (or operable) to engage with a corresponding feature on the filter securing the filter to the first and second base members.

According to yet another aspect, the opening is configured (or operable) to receive an end of the filter.

According to yet another aspect, the filter is a cartridge filter.

According to yet another aspect, the filter is a D.E. filter.

According to yet another aspect, the bottom surface comprises a first channel and a second channel extending from the opening to a perimeter of the base members, and where the first and second channels are adapted to receive an elongated member.

According to yet another aspect, the first channel and the second channel are perpendicular to each other.

According to yet another aspect, a first end of the elongated member is received in the first or second channel of the filter assembly, and wherein a second end of the elongated member is connected to a different filter assembly.

According to yet another aspect, the filter stand further comprises drain holes located in the top and bottom surfaces.

According to yet another aspect, the first and second wall members are arcuate.

According to another example, a filter stand assembly is provided. The filter stand assembly comprises a plurality of filter assemblies configured (or operable) to be detachably connected together. Each filter assembly in the plurality of filter assemblies comprises a first base member, a second base member, and a filter detachably connected between the first base member and the second base member. The first and second base members are identical and each of the first and second base members comprises a top surface and an opposing bottom surface, an outer side wall integrally connected to and extending between the top and bottom surfaces; an opening extending between the top surface and the bottom surface, where an inner side wall extending between the top surface and the bottom surface defines the opening; first and second protrusions extending outward from the inner side wall into the opening, the first protrusion opposite the second protrusion; and first and second wall members extending perpendicularly upward from the top surface, the first wall member opposite the second wall member and separated by the opening.

According to one aspect, the first and second protrusions are configured (or operable) to engage with a corresponding feature on the filter securing the filter to the first and second base members.

According to another aspect, the bottom surface of each of the filter assemblies comprises a first and a second channel extending from the opening to a perimeter of the base members, and where the first and second channels are adapted to receive an elongated member.

According to yet another aspect, the first channel and the second channel are perpendicular to each other.

According to yet another example, a filter stand assembly is provided. The filter stand assembly comprises a first filter assembly; a second filter assembly detachably connected to the first filter assembly; a third filter assembly detachably connected to the first filter assembly; and a fourth filter assembly detachably connected to the second and third filter assemblies. Each of the first, second, third, and fourth filter assemblies comprises a first base member, a second base member, and a filter detachably connected between the first base member and the second base member. Each of the first and second base members comprise a top surface and an opposing bottom surface, an outer side wall integrally connected to and extending between the top and bottom surfaces; an opening extending between the top surface and the bottom surface, where an inner side wall extending between the top surface and the bottom surface defines the opening; first and second protrusions extending outward from the inner side wall into the opening, the first protrusion opposite the second protrusion; and first and second wall members extending perpendicularly upward from the top surface, the first wall member opposite the second wall member and separated by the opening.

According to one aspect, the first and second protrusions are configured (or operable) to engage with a corresponding feature on the filter securing the filter to the first and second base members.

According to another aspect, the bottom surface of each of the filter assemblies comprises a first and a second channel extending from the opening to a perimeter of the base members, and where the first and second channels are adapted to receive an elongated member.

According to yet another aspect, the first channel and the second channel are perpendicular to each other.

According to yet another aspect, the filter stand assembly further comprises a first elongated member detachably connecting the first filter assembly to the second filter assembly; a second elongated member detachably connecting the first filter assembly to the third filter assembly; a third elongated member detachably connecting the second filter assembly to a fourth filter assembly; and a fourth elongated member detachably connecting the third filter assembly to the fourth filter assembly.

### BRIEF DESCRIPTION OF THE DRAWINGS

FIG. 1 illustrates a front perspective view of a filter stand, according to one embodiment of the present disclosure.

FIG. 2 illustrates a front perspective view of a base member of the filter stand of FIG. 1.

FIG. 3 illustrates a top plan view of the base member of the filter stand of FIG. 1.

FIG. 4 illustrates a bottom plan view of the base member of the filter stand of FIG. 1.

FIG. 5 illustrates a cross-sectional view of a filter secured to the base member taken along line 5-5 in FIG. 1.

FIG. 6 illustrates a front perspective view of a filter stand, according to another embodiment of the present disclosure.

FIG. 7 illustrates a cross-sectional view of a filter secured to a base member taken along line 5-5 in FIG. 6.

FIG. 8 illustrates a front perspective view of a filter stand, according to another embodiment of the present disclosure.

FIG. 9 illustrates a bottom plan view of a base member of the filter stand of FIG. 8.

### DETAILED DESCRIPTION

The following detailed description is of the best currently contemplated modes of carrying out the invention. The description is not to be taken in a limiting sense, but is made merely for the purpose of illustrating the general principles of the invention. Furthermore, in the following description, specific details are given to provide a thorough understanding of the embodiments. However, it will be understood by one of ordinary skill in the art that the embodiments may be practiced without these specific details.

While the present disclosure is described primarily with respect to pool filters, the present disclosure may be applied and adapted to various applications. The present disclosure may be applied to any filter that needs to be cleaned.

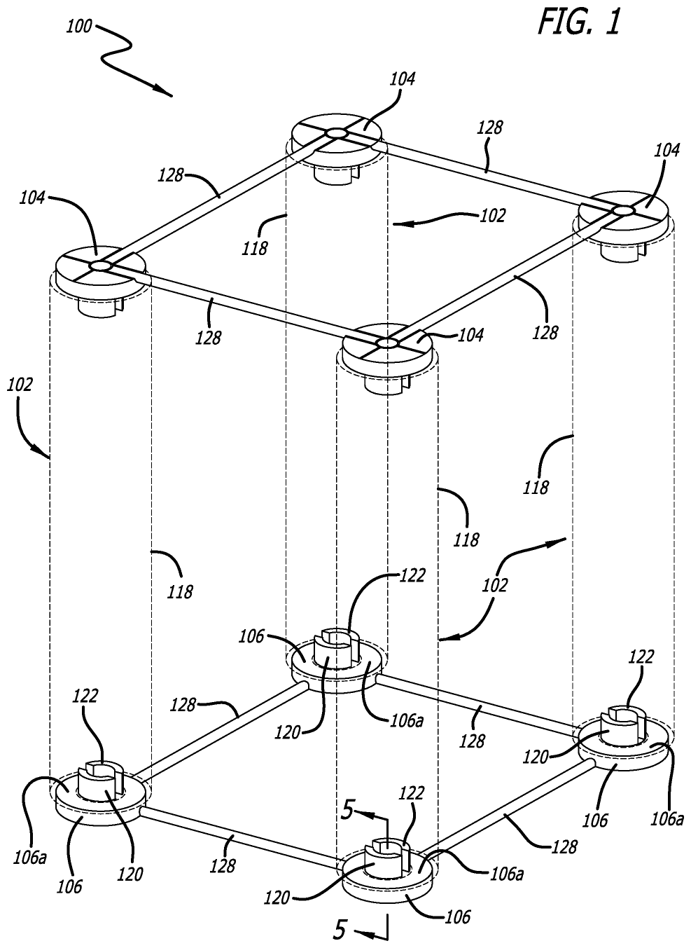

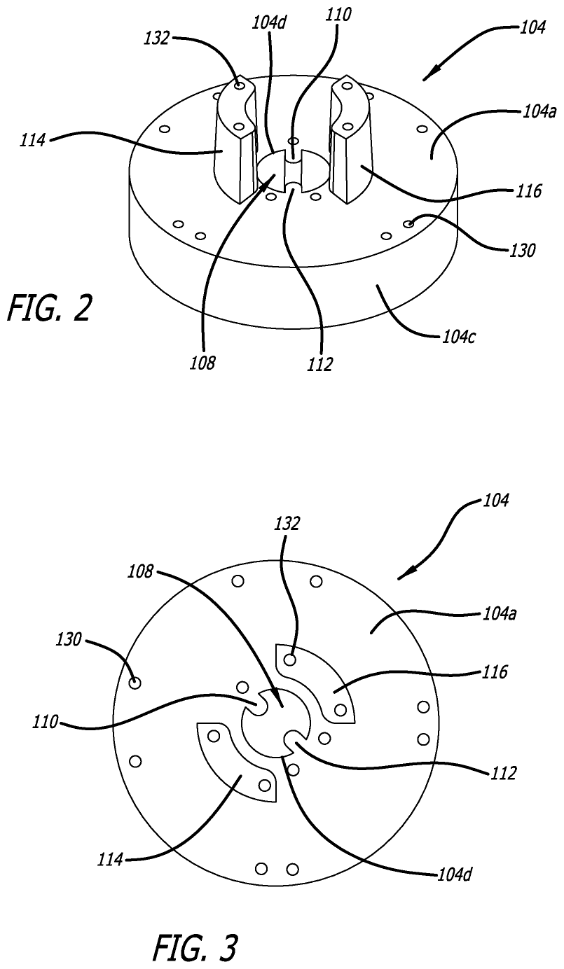

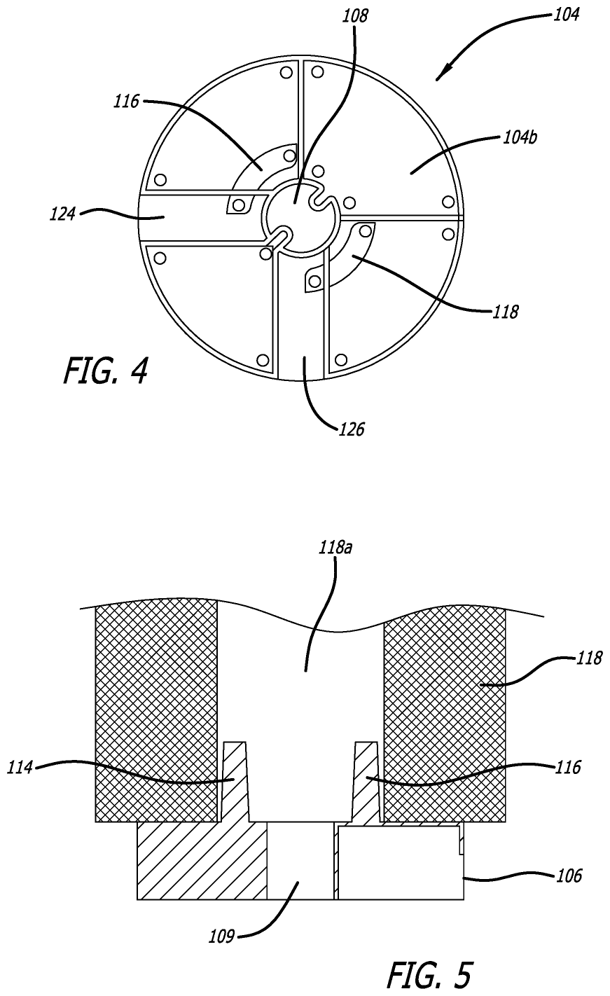

FIG. 1 illustrates a front perspective view of a filter stand 100, according to one embodiment of the present disclosure. FIG. 2 illustrates a front perspective view of a base member of the filter stand of FIG. 1. FIG. 3 illustrates a top plan view of the base member of the filter stand of FIG. 1. FIG. 4 illustrates a bottom plan view of the base member of the filter stand of FIG. 1. FIG. 5 illustrates a cross-sectional view of a filter secured to the base member taken along line 5-5 in FIG. 1. The following discussion refers interchangeably to FIGS. 1-5.

Turning to FIG. 1, a filter stand 100 comprising a plurality of filter assemblies 102 is shown. Although four (4) filter assemblies are shown, this is by way of example only. Each filter assembly 102 comprises a first base member 104 and an opposing second base member 106. The first base member 104 includes a top surface 104a and an opposing bottom surface 104b integrally connected by an outer side wall 104c. One or more drain holes 130 may be located in the top and bottom surfaces 104a, 104b of the first base member 104 for allowing water to drain.

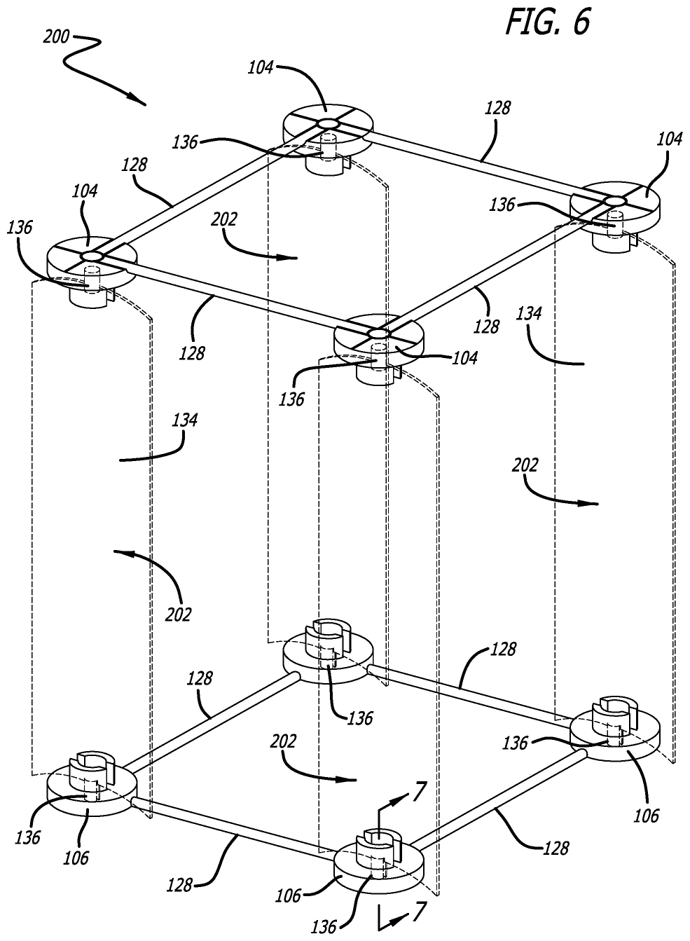

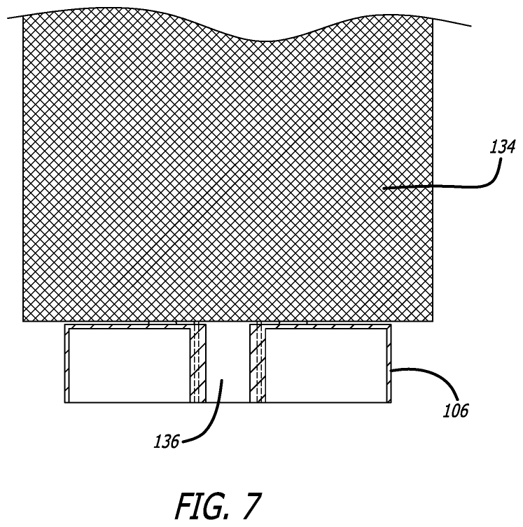

An opening 108, formed in the first base member 104, is defined by an inner side wall 104d which extends between the top surface 104a and the bottom surface 104b. The opening 108 is configured (or operable) to receive an end of a DE filter, described below in further detail with respect to FIGS. 6-7. According to one embodiment, the opening 108 may be located in the center or middle of the first base member 104 and have a generally circular configuration. The generally circular configuration is by way of example only and in alternative embodiments, the opening may be other shapes, such as ovals, triangles, squares, or other polygons.

A first protrusion 110 and a second protrusion 112 may be integrally connected to, and extend outwardly from, the inner side wall 104d into the opening 108. The first and second protrusions 110, 112 may extend the entire vertical length of the inner side wall 104d. Alternatively, the first and second protrusions 110, 112 may extend vertically along a partial vertical length of the inner side wall 104d. According to one example, the first protrusion 110 may be parallel to, and directly opposite, the second protrusion 112.

A first wall member 114 and a second wall member 116 extend perpendicularly upward from the top surface 104a of the first base member 104 and separated by the opening 108. One or more drain holes 132 may be located in the first and second wall members 114, 116 of the first base member 104 for allowing water to drain.

The first wall member 114 may be parallel to, and directly opposite, the second wall member 116. According to one embodiment, the first and second wall members 114, 116 may be mirror images of each other and each of the first and second wall members 114, 116 may have an arcuate shape designed to receive an end of a cartridge filter and retain the filter within the filter stand 100.

The bottom surface 104b of the first base member 104 may include a first channel 124 and a second channel 126 extending from the opening 108 to a perimeter of the first base member 104. Each of the first and second channels 124, 126 are adapted to receive an elongated member 128 and may be located perpendicular to each other.

According to one embodiment, one or more elongated members 128 are configured (or operable) to detachably connect multiple first base members 104 together, as shown in FIG. 1, to create a larger, cohesive structure with a square or grid-like arrangement. To form the structure, a first end of an elongated member 128 is received in a first or second channel of a first base member and the second end of the elongated member 128 is received in a first or second channel of a different first base member.

Similarly, one or more elongated members 128 are configured (or operable) to detachably connect multiple second base members 106 together, as shown in FIG. 1, to create a larger, cohesive structure with a square or grid-like arrangement. To form the structure, a first end of an elongated member 128 is received in a first or second channel of a second base member and the second end of the elongated member 128 is received in a first or second channel of a different second base member in a different filter assembly. As shown, a first elongated member detachably connects a first filter assembly to the second filter assembly; a second elongated member detachably connects the first filter assembly to the third filter assembly; a third elongated member detachably connects the second filter assembly to a fourth filter assembly; and a fourth elongated member detachably connects the third filter assembly to the fourth filter assembly.

As shown in FIG. 1, a filter assembly 102 is comprised of the cartridge filter 118 detachably secured to the first and second base members 104, 106. More specifically, a first filter end is detachably secured to the first base member 104 and a second filter end is detachably secured to the second base member 106. The filter assemblies 102 may be interconnected to create a larger, cohesive structure with a square or grid-like arrangement. This design offers versatility, allowing for the assembly of various configurations and shapes by linking these modular platforms together.

The second base member 106 is identical to the first base member 104. As with the first base member 104, the second base member 106 includes a top surface 106a and an opposing bottom surface 106b integrally connected by an outer side wall. One or more drain holes may be located in the top and bottom surfaces 106a, 106b of the second base member 106 for allowing water to drain.

An opening 109, formed in the second base member 106, is defined by an inner side wall which extends between the top surface and the bottom surface 106a, 106b. The opening in the second base member 106 is configured (or operable) to receive an end of a DE filter, described below in further detail with respect to FIGS. 6-7. According to one embodiment, the opening 109 may be located in the center or middle of the second base member 106 and have a generally circular configuration. The generally circular configuration is by way of example only and in alternative embodiments, the opening may be other shapes, such as ovals, triangles, squares, or other polygons.

A first protrusion 110 and a second protrusion 112 may be integrally connected to, and extend outwardly from, the inner side wall into the opening of the second base member. The first and second protrusions 110, 112 may extend the entire vertical length of the inner side wall. Alternatively, the first and second protrusions 110, 112 may extend vertically along a partial vertical length of the inner side wall. According to one example, the first protrusion may be parallel to, and directly opposite, the second protrusion 112.

A first wall member 114 and a second wall member 116 extend perpendicularly upward from the top surface 106a of the second base member 106 and separated by the opening. One or more drain holes 132 may be located in the first and second wall members 114, 116 of the second base member 106 for allowing water to drain.

The first wall member 114 may be parallel to, and directly opposite, the second wall member 116. According to one embodiment, the first and second wall members 114, 116 may be mirror images of each other and each of the first and second wall members 114, 116 may have an arcuate shape designed to receive an end of a cartridge filter and retain the filter within the filter stand 100.

FIG. 5 illustrates a cross-sectional view of a cartridge filter 118 secured to the second base member 106. As shown, the cartridge filter 118 has a hole 118a which is configured (or operable) to receive the first and second wall members 114, 116 of the second base member 106. In other words, the hole 118a of cartridge filter 118 is placed over the first and second wall members 114, 116 of the second base member 106 detachably securing one end of the cartridge filter 118 to the second base member 106. Furthermore, the first and second protrusions 110, 112 are configured (or operable) to engage with a corresponding feature on the filter 118 securing the filter 118 to the first and second base members 104, 106.

FIG. 6 illustrates a front perspective view of a filter stand 200 comprising a plurality of filter assemblies 202, according to another embodiment of the present disclosure. Although four (4) filter assemblies are shown, this is by way of example only. As with the filter stand 100 of FIG. 1, each filter assembly 202 comprises a first base member 104 and an opposing second base member 106. The first and second base members 104, 106 as described previously with respect to FIGS. 1-5, may be utilized in the filter stand 200 of FIG. 6.

The bottom surface 104b of the first base member 104 may include a first channel 124 and a second channel 126 extending from the opening 108 to a perimeter of the first base member 104. Each of the first and second channels 124, 126 are adapted to receive an elongated member 128 and may be located perpendicular to each other.

According to one embodiment, one or more elongated members 128 are configured (or operable) to detachably connect multiple first base members 104 together, as shown in FIG. 6, to create a larger, cohesive structure with a square or grid-like arrangement. To form the structure, a first end of an elongated member 128 is received in a first or second channel of a first base member 104 and the second end of the elongated member 128 is received in a first or second channel of a different first base member 104 of a different filter assembly.

Similarly, one or more elongated members 128 are configured (or operable) to detachably connect multiple second base members 106 together, as shown in FIG. 6, to create a larger, cohesive structure with a square or grid-like arrangement. To form the structure, a first end of an elongated member 128 is received in a first or second channel of a second base member and the second end of the elongated member 128 is received in a first or second channel of a different second base member. As shown, a first elongated member detachably connects a first filter assembly to the second filter assembly; a second elongated member detachably connects the first filter assembly to the third filter assembly; a third elongated member detachably connects the second filter assembly to a fourth filter assembly; and a fourth elongated member detachably connects the third filter assembly to the fourth filter assembly.

FIG. 7 illustrates a cross-sectional view of a DE filter 134 secured to the second base member 106 taken along line 5-5 in FIG. 6. DE filters 134 comprise a filter fabric or mesh attached to a frame having a connector 136 on one end of the frame. As shown, the connector on the end of the frame is configured (or operable) to be received in the opening formed in the second base member 106 and a bottom portion of the filter fabric or mesh is retained between the first and second wall members 114, 116 of the second base member 106.

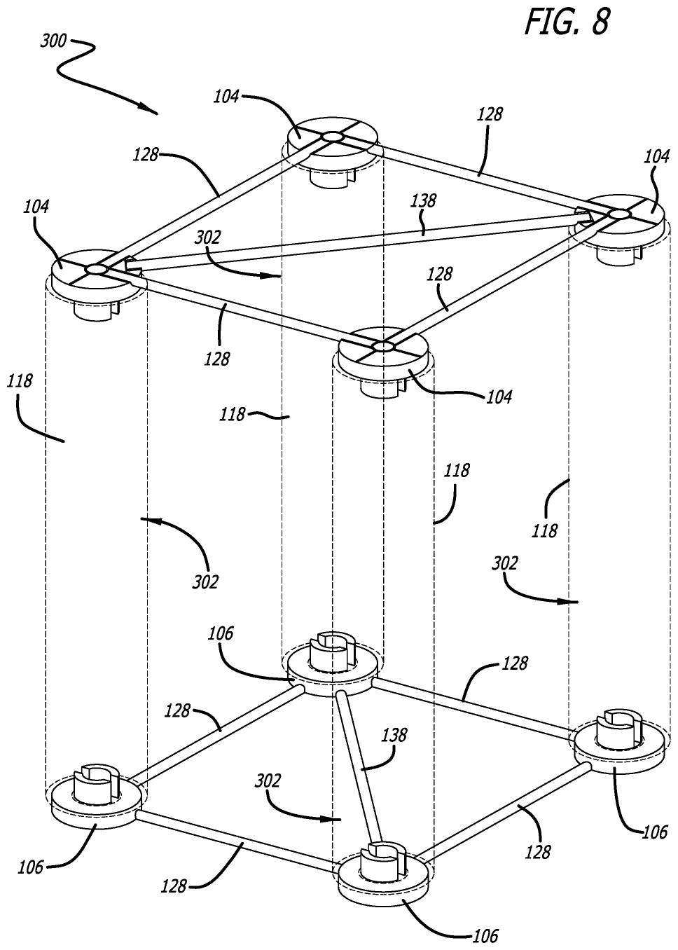

FIG. 8 illustrates a front perspective view of a 1 filter stand 300 comprising a plurality of filter assemblies 302, according to another embodiment of the present disclosure. Although four (4) filter assemblies are shown, this is by way of example only. As with the filter stand 100 of FIG. 1, each filter assembly 302 comprises a first base member 104 and an opposing second base member 106. The first and second base members 104, 106 as described previously with respect to FIGS. 1-5, may be utilized in the filter stand 300 of FIG. 8. As shown, a first elongated member detachably connects a first filter assembly to the second filter assembly; a second elongated member detachably connects the first filter assembly to the third filter assembly; a third elongated member detachably connects the second filter assembly to a fourth filter assembly; and a fourth elongated member detachably connects the third filter assembly to the fourth filter assembly.

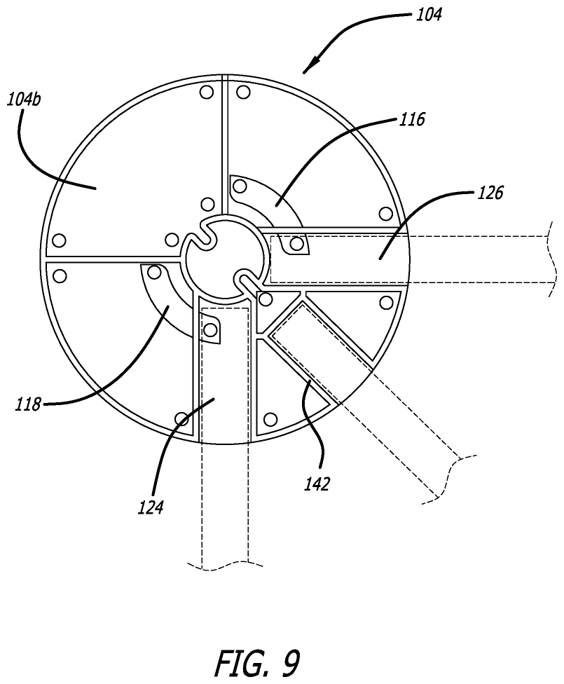

FIG. 9 illustrates a bottom plan view of a base member of the filter stand 300 of FIG. 8. In this embodiment, the bottom surface 104b of the first base member 104 may include a first channel 124, a second channel 126, and a third channel 142 extending from the opening 108 to a perimeter of the first base member 104. Each of the first and second channels 124, 126 are configured (or operable) to receive an elongated member 128 and may be located perpendicular to each other. The third channel 142 may be located equidistant between the first and second channels 124, 126 and configured (or operable) to receive an elongated support arm 138.

According to one embodiment, one or more elongated members 128 are configured (or operable) to detachably connect multiple first base members 104 together, as shown in FIG. 8, to create a larger, cohesive structure with a square or grid-like arrangement. To form the structure, a first end of an elongated member 128 is received in a first or second channel of a first base member and the second end of the elongated member 128 is received in a first or second channel of a different first base member of a different filter assembly.

Similarly, one or more elongated members 128 are configured (or operable) to detachably connect multiple second base members 106 together, as shown in FIG. 8, to create a larger, cohesive structure with a square or grid-like arrangement. To form the structure, a first end of an elongated member 128 is received in a first or second channel of a second base member and the second end of the elongated member 128 is received in a first or second channel of a different second base member of a different filter assembly.

According to one embodiment, the elongated support arm 138 is configured (or operable) to be received in the third channel 142 of a pair of first base members 104 which are located catty corner to each other. Similarly, an elongated support arm 138 is configured (or operable) to be received in the third channel 142 of a pair of second base members 106 which are located catty corner to each other. The elongated support arms 138 provide further support and structure to the filter stand 300.

One or more of the components and functions illustrated in FIGS. 1-9 may be rearranged and/or combined into a single component or embodied in several components without departing from the invention. Additional elements or components may also be added without departing from the invention.

While certain exemplary embodiments have been described and shown in the accompanying drawings, it is to be understood that such embodiments are merely illustrative of and not restrictive on the broad invention, and that this invention is not be limited to the specific constructions and arrangements shown and described, since various other modifications may occur to those ordinarily skilled in the art.

1. A filter assembly, comprising:
a first base member;
a second base member, each of the first and second base members comprising:
a top surface and an opposing bottom surface, an outer side wall integrally connected to and extending between the top and bottom surfaces;
an opening extending between the top surface and the bottom surface, where an inner side wall extending between the top surface and the bottom surface defines the opening;
first and second protrusions extending outward from the inner side wall into the opening, the first protrusion opposite the second protrusion; and
first and second wall members extending perpendicularly upward from the top surface, the first wall member opposite the second wall member and separated by the opening; and
a filter detachably connected between the first base member and the second base member.

2. The filter assembly of claim 1, wherein the first and second wall members are integrally connected to the top surface.

3. The filter assembly of claim 1, wherein the first and second protrusions are operable to engage with a corresponding feature on the filter securing the filter to the first and second base members.

4. The filter assembly of claim 1, wherein the opening is operable to receive an end of the filter.

5. The filter assembly of claim 1, wherein the filter is a cartridge filter.

6. The filter assembly of claim 1, wherein the filter is a D.E. filter.

7. The filter assembly of claim 1, wherein the bottom surface comprises a first channel and a second channel extending from the opening to a perimeter of the base members; wherein the first and second channels are adapted to receive an elongated member; and wherein the first channel and the second channel are perpendicular to each other.

8. The filter assembly of claim 7, wherein the bottom surface further comprises a third channel located equidistant between the first and second channels; wherein the third channel is adapted to receive an elongated support arm; and wherein the elongated support arm is operable to be received in the third channel of a pair of base members which are located catty corner to each other.

9. The filter assembly of claim 7, wherein a first end of the elongated member is received in the first or second channel of the filter assembly, and wherein a second end of the elongated member is connected to a different filter assembly.

10. The filter assembly of claim 7, further comprising drain holes located in the top and bottom surfaces.

11. The filter assembly of claim 1, wherein the first and second wall members are arcuate.

12. A filter stand assembly, comprising:
a plurality of filter assemblies configured to be detachably connected together, each filter assembly in the plurality of filter assemblies comprising
a first base member;
a second base member, each of the first and second base members comprising:
a top surface and an opposing bottom surface, an outer side wall integrally connected to and extending between the top and bottom surfaces;
an opening extending between the top surface and the bottom surface, where an inner side wall extending between the top surface and the bottom surface defines the opening;
first and second protrusions extending outward from the inner side wall into the opening, the first protrusion opposite the second protrusion; and
first and second wall members extending perpendicularly upward from the top surface, the first wall member opposite the second wall member and separated by the opening; and
a filter detachably connected between the first base member and the second base member.

13. The filter stand assembly of claim 12, wherein the first and second protrusions are configured to engage with a corresponding feature on the filter securing the filter to the first and second base members.

14. The filter stand assembly of claim 12, wherein the bottom surface of each of the filter assemblies comprises a first and a second channel extending from the opening to a perimeter of the base members, and where the first and second channels are adapted to receive an elongated member.

15. The filter stand assembly of claim 14, wherein the first channel and the second channel are perpendicular to each other.

16. A filter stand assembly, comprising:
a first filter assembly;
a second filter assembly detachably connected to the first filter assembly;
a third filter assembly detachably connected to the first filter assembly;
a fourth filter assembly detachably connected to the second and third filter assemblies, each of the first, second, third, and fourth filter assemblies comprising:
a first base member;
a second base member, each of the first and second base members comprising:
a top surface and an opposing bottom surface, an outer side wall integrally connected to and extending between the top and bottom surfaces;
an opening extending between the top surface and the bottom surface, where an inner side wall extending between the top surface and the bottom surface defines the opening;
first and second protrusions extending outward from the inner side wall into the opening, the first protrusion opposite the second protrusion; and
first and second wall members extending perpendicularly upward from the top surface, the first wall member opposite the second wall member and separated by the opening; and
a filter detachably connected between the first base member and the second base member.

17. The filter stand assembly of claim 14, wherein the first and second protrusions are configured to engage with a corresponding feature on the filter securing the filter to the first and second base members.

18. The filter stand assembly of claim 14, wherein the bottom surface of each of the filter assemblies comprises a first channel and a second channel extending from the opening to a perimeter of the base members, and where the first and second channels are adapted to receive an elongated member.

19. The filter assembly of claim 18, wherein the first channel and the second channel are perpendicular to each other.

20. The filter stand assembly of claim 16, further comprising:
a first elongated member detachably connecting the first filter assembly to the second filter assembly;
a second elongated member detachably connecting the first filter assembly to the third filter assembly;
a third elongated member detachably connecting the second filter assembly to a fourth filter assembly; and
a fourth elongated member detachably connecting the third filter assembly to the fourth filter assembly.
